(19) United States
(12) Patent Application Publication
(10) Pub. No.: US 2006/0101260 A1
(43) Pub. Date: May 11, 2006

(54) Rebooting card and its method for determining a timing of restarting a reset mechanism

(76) Inventor: Robert Shih, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/105,469

(22) Filed: Apr. 14, 2005

(30) Foreign Application Priority Data
Nov. 5, 2004 (TW) 093133838

(51) Int. Cl. G06F 15/177

(52) U.S. Cl. 713/2

(57) ABSTRACT

A rebooting card and its method for determining a timing of restarting a reset mechanism are proposed. The rebooting card is plugged into a socket of a motherboard of a computer system and includes a detection unit, a counter and a reset unit. It functions together with the basic input/output system (BIOS) of the motherboard. When the computer system activates the BIOS and finishes the booting procedure, it sends a finish code to the rebooting card for notification. When the detection unit detects and receives the finish code, it drives the counter to count to a present value so as to drive the reset unit to restart the reset mechanism of the motherboard for testing. Thus, in case that the computer system doesn't finish its booting procedure, the detection unit of the rebooting card will not receive the finish code so that the rebooting card won't restart the reset mechanism.

### BACKGROUND OF THE INVENTION

1. Field of the Invention

The present invention is related to a rebooting card and its method for determining a timing of restarting a reset mechanism, and more particularly, to a rebooting card and its method that are used to determine whether a computer system has finished its booting procedure and thereby determine a timing for restarting the reset mechanism of the motherboard inside the computer system. In this way, the test for the reset mechanism of the motherboard is continued only after the computer system finishes performing its booting procedure.

2. Description of Related Art

With the rapid progress of technologies, the functions of computer systems are more and more powerful and provide quite many conveniences for people. Nowadays, all of the computer systems have a reset mechanism. Thus, when the computer system is down, the reset mechanism can be used to restart the computer system. This reset mechanism is implemented as the power button or reset button of the computer host.

The reset mechanism is provided in the motherboard of the computer system, in which the motherboard has power button pins and reset pins. When the power button pins are short-circuited for a few seconds, the motherboard will cut off the power supply to turn off the computer system. After that, the user can restart the computer system by making the power button pins short-circuited again. On the other hand, it only needs to make the reset pins short-circuited once to cut off the power supply of the system chips and restart the computer system.

Before the computer system is marketed, in order to confirm the reset mechanism functions normally and stably, the reset mechanism of the computer system will be tested for quite a few times. In early periods, the reset mechanism is tested manually. It is very time-consuming. Afterward, hardware rebooting cards were developed to automatically make the power button pins short-circuited for a few seconds and then make the power button pins or the reset pins short-circuited to test the reset mechanism.

When a common rebooting card tests the reset mechanism, it cyclically makes the power button pins or reset pins short-circuited after a fixed time to restart the computer system. This fixed time is enough for a computer system to finish its booting operations. However, using this kind of cards produces a problem. That is the rebooting card is bound to activate the reset mechanism of the motherboard after a fixed time period no matter what situation occurs in the computer system.

Thus, suppose that the computer system hasn't finished its booting operations (it means the operating system (OS) has not been activated yet) and the booting procedure is interrupted. For example, the computer system may crash due to erroneous execution of the booting procedure for initializing the hard disk. At this situation, the computer system should be idle for a tester to check rather than be restarted. However, the foresaid rebooting card is not capable of checking whether the rebootinging procedure is completed or not. It keeps restarting the reset mechanism of the motherboard after the fixed time no matter what kind of situation occurs. Hence, a tester cannot know the erroneous booting statues via the conventional rebooting cards.

Aiming to resolve this problem, some of the present rebooting cards can detect the value of the current of the motherboard or central processing unit (CPU) to determine whether the reset mechanism should be activated again or not. This kind of rebooting cards needs to have an additional complicated circuit for current detection. It increases the cost unavoidably. Besides, using this method cannot correctly determine whether the computer system finishes its booting procedure or not. Hence, the problem mentioned above cannot be solved still.

Therefore, in order to resolve the foresaid problem, the present invention provides a novel rebooting card and its method for determining the timing of restarting a reset mechanism. By using the basic input/output system (BIOS) of the motherboard, it can correctly determine whether the computer system finishes its rebooting procedure or not so as to determine whether the next test should be continued. Moreover, it can reduce the cost also.

### SUMMARY OF THE INVENTION

An objective of the present invention is to provide a rebooting card that is capable of functioning together with the basic input/output system (BIOS) of a motherboard. Therein, the BIOS sends a finish code to the rebooting card after its booting procedure is performed completely. When the rebooting card receives the finish code, it can determine that the computer system finishes it booting procedure and restart the reset mechanism again. Thus, the rebooting card can correctly determine the timing of restarting the reset mechanism in test.

Another objective of the present invention is to provide a rebooting card that is capable of functioning together with the BIOS of a motherboard to correctly determine the timing for restarting the reset mechanism so as to reduce the cost.

For achieving the objectives above, the present invention provides a rebooting card and its method for determining a timing of restarting a reset mechanism. It is used together with the BIOS of the computer system. When the computer system activates the BIOS for booting and finishes the booting procedure, it sends a finish code to the rebooting card for notification. The rebooting card includes a detection unit, a counter and a reset unit. The method for the rebooting card to determine the timing of restarting the reset mechanism includes using the detection unit to detect and receive the finish code to determine whether the computer system finishes performing the booting procedure; using the counter to count to a present value so as to drive the reset unit to restart the reset mechanism of the motherboard for testing. Therein, receiving the finish code means the computer system has finished performing its booting procedure.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram of a preferred embodiment in accordance with the present invention; and

FIG. 2 is a flow chart of a preferred embodiment in accordance with the present invention.

### DETAILED DESCRIPTION OF PREFERRED EMBODIMENTS

The present invention is used together with the BIOS of the motherboard. When the computer system activates the BIOS and finishes the booting procedure, it sends a finish code to the rebooting card of the present invention for notification. After that, the rebooting card can restarts the reset mechanism of the motherboard for testing.

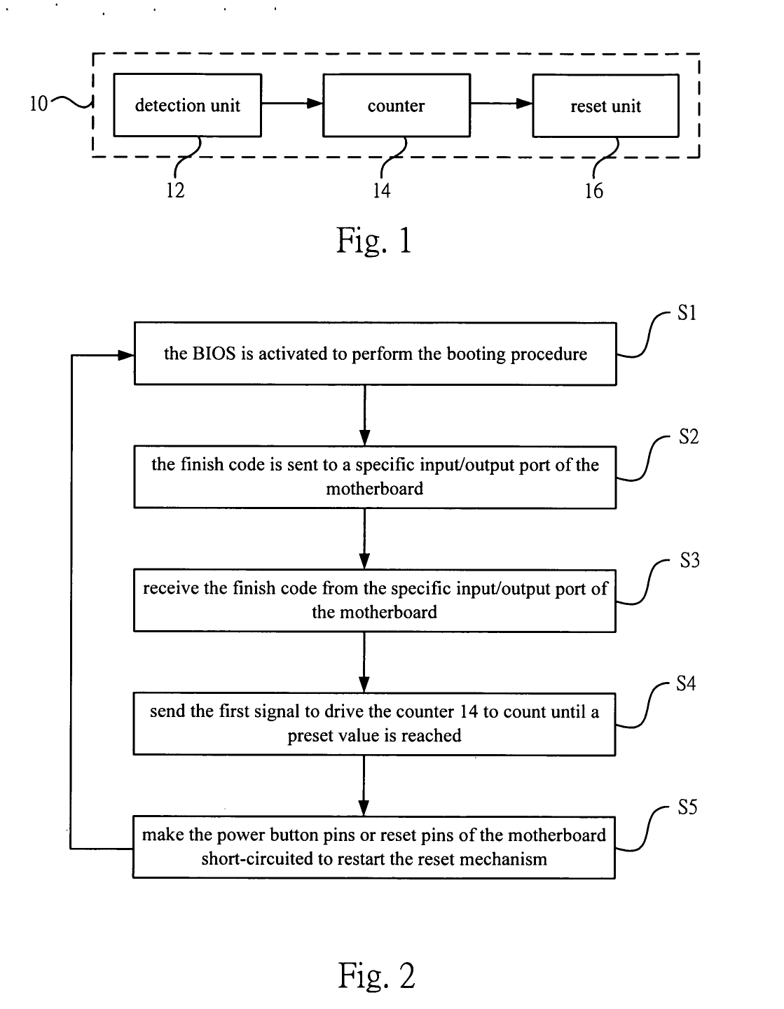

Reference is made to FIG. 1, which is a block diagram of a preferred embodiment in accordance with the present invention. The rebooting card 10 of the present invention is used for a tester to check the reset mechanism of a motherboard before it is marketed. Initially, the rebooting card needs to be plugged into a socket of a motherboard of a computer system. The rebooting card 10 is used together with the BIOS of the motherboard. After the BIOS finishes all of the commands of the booting procedure, the present invention makes the BIOS to output a finish code. It means that the present invention makes the BIOS to output a specific value via an input/output port of the motherboard after the booting procedure is finished. Thus, before the operating system (OS) is started, the rebooting card 10 can detect the finish code and thereby determine whether the booting procedure is finished or not. Therein, the foresaid input/output port can be one of the input/output ports 80h˜84h.

The rebooting card 10 includes a detection unit 12, a counter 14 and a reset unit 16. The detection unit 12 is used to detect the finish code outputted from the BIOS via the predetermined input/output port. When the detection unit 12 detects the finish code, it means the booting procedure is finished. At this moment, the detection unit 12 sends a first signal to the counter 14 to make it count to a preset value and then send a second signal to the reset unit 16. After receiving the second signal, the reset unit 16 activates the reset mechanism. It means that the reset unit 16 first makes the power button pins short-circuited for a few seconds to cut off the power supply for the system chips and then makes the power button pins short-circuited again to recover the power supply. In this way, the BIOS is restarted to perform the booting procedure. Moreover, the reset unit 16 can also make the reset pins short-circuited to activate the reset mechanism.

The reference is made to FIG. 1 together with FIG. 2, which is a flow chart of a preferred embodiment in accordance with the present invention. When the computer system is turned on, the BIOS is activated to perform the booting procedure (step S1). After the booting procedure is completed, the finish code is sent to a specific input/output port of the motherboard (step S2). However, if the computer system is down when the booting procedure is performed, step S2 will not be performed. Thus, the rebooting card 10 will not restart the reset mechanism of the motherboard. Therefore, in this way, a tester can know the status of failure and resolve the problem. It should be noted that when step S1 is performed to boot the computer system, the detection unit 12 of the rebooting card 10 keeps detecting the specific input/output port of the motherboard to receive the finish code.

When step S2 is completed, the detection unit 12 can receive the finish code from the specific input/output port of the motherboard (step S3) and send the first signal to drive the counter 14 to count until a preset value is reached (step S4). After the counting is finished, the counter 14 sends the second signal to the reset unit 16 to make the power button pins or reset pins of the motherboard short-circuited to restart the reset mechanism (step S5). In the foresaid step S4, the counting process makes the computer system have enough time to finish activating its operating system. Thus, the reset mechanism is restarted only after the operating system is activated completely. Therefore, as above description, the rebooting card 10 of the present invention can restart the reset mechanism of the motherboard for test after the computer system finishes its booting procedure of the BIOS and the operating system.

Summing up, the rebooting card of the present invention and its method for determining the timing of restarting a reset mechanism can function together with the BIOS of the motherboard. The BIOS sends a finish code to a specific input/output port of the motherboard after it finishes its booting procedure. Then, when the rebooting card of the present invention receives the finish code, it automatically activates the reset mechanism of the motherboard for testing. Otherwise, if the rebooting card doesn't receive the finish code, it will not activate the reset mechanism again.

Moreover, since the detection unit of the rebooting card is only used to detect the specific input/output port of the motherboard and receive the finish code, its circuit is very simple. Hence, compared with the prior art that uses a detection circuit to detect the current in the CPU or motherboard, the detection unit of the present invention has a lower cost. In addition, adding a command into the BIOS is very simple and doesn't need too much time or money.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A rebooting card, which is plugged into a socket of a motherboard of a computer system to test a reset mechanism of the motherboard, the computer system performs a basic input/output system (BIOS) of the motherboard and then sends a finish code to the rebooting card after a booting procedure of the BIOS is finished to inform the rebooting card that the booting procedure is completed, the rebooting card comprising:
a detection unit for detecting and receiving the finish code and sending a first signal after the finish code is detected and received;
a counter for receiving the first signal and sending out a second signal after a preset value of time; and
a reset unit for receiving the second signal and driving the motherboard to activate the reset mechanism again.

2. The rebooting card as claimed in claim 1, wherein the finish code is sent to one of input/output ports 80h˜84h of the motherboard and the detection unit is used to detect the one of the input/output ports 80h˜84h to receive the finish code.

3. The rebooting card as claimed in claim 1, wherein the reset unit makes a power button pin of the motherboard short-circuited for a few seconds to cut off a power supply, and then makes power button pins short-circuited again to recover the power supply and activate the BIOS to rebooting the computer system.

4. The rebooting card as claimed in claim 1, wherein the reset unit makes a reset pin of the motherboard short-circuited to cut off a power supply of the motherboard and then recover the power supply to restart the BIOS to rebooting the computer system.

5. The rebooting card as claimed in claim 1, wherein the counter counts to the preset value to provide a sufficient time for the computer system to activate an operating system (OS) completely and then the reset unit activates the reset mechanism of the motherboard.

6. A method for determining a timing of restarting a reset mechanism be used with a BIOS of a motherboard of a computer system, and performing a booting procedure of computer system finished and a finish code send, comprising:
detecting and receiving the finish code to determine;
counting to a preset value after the finish code is received; and
restarting the reset mechanism of the motherboard.

7. The method as claimed in claim 6, wherein after the computer system finishes performing the booting procedure of the BIOS, in the step of detecting and receiving the finish code, the rebooting card doesn't receive the finish code, it means the computer system doesn't finish the booting procedure of the BIOS, the rebooting code doesn't proceed the step of counting to the preset value and the step of restarting the reset mechanism.

8. The method as claimed in claim 6, wherein after the computer system finishes performing the booting procedure of the BIOS, in the step of detecting and receiving the finish code, the finish code is obtained from one of input/output ports 80h˜84h of the motherboard and the rebooting card detects the one of the input/output ports 80h˜84h to receive the finish code.

9. The method as claimed in claim 6, wherein in the step of restarting the reset mechanism of the motherboard, a power button pin of the motherboard are short-circuited for a few seconds to cut off a power supply and then short-circuited again to recover the power supply to restart the BIOS to rebooting the computer system.

10. The method as claimed in claim 6, wherein the in the step of restarting the reset mechanism of the motherboard, a reset pin of the motherboard are short-circuited to cut off a power supply and then recover the power supply again to restart the BIOS to rebooting the computer system.

11. The method as claimed in claim 6, wherein the step of counting to the preset value is used to provide a sufficient time for the computer system to activate an operating system (OS) completely and then activate the reset mechanism of the motherboard again.
